(19) United States
(12) Patent Application Publication
(10) Pub. No.: US 2021/0241571 A1
(43) Pub. Date: Aug. 5, 2021

(54) SYSTEMS AND METHODS FOR GENERATING PRIZES FOR ELECTRONIC GAMING MACHINES HAVING COLORED NUMBERS AS GAME INDICIA

(71) Applicant: Shad Leriche, Montreal (CA)

(72) Inventor: Shad Leriche, Montreal (CA)

(21) Appl. No.: 16/780,732

(22) Filed: Feb. 3, 2020

(51) Int. Cl. G07F 17/32

(52) U.S. Cl. CPC G07F 17/3213; G07F 17/3267; G07F 17/3258; G07F 17/3293

(57) ABSTRACT

A gaming system and method including a primary game display comprising a series of reels which randomly display game indicia involving colored numbers and a selected numbers grid. The primary game display may comprise three cards or paylines each having five game indicia locations/reels, each corresponding to a unique color, wherein the selected numbers grid also has five selected numbers, each corresponding to a unique color. During play, each of the game indicia reels displays a random number, from a group of numbers, of a particular color. Winning outcomes relate to several factors including (i) random game indicia matching the corresponding selected number and color; (ii) random game indicia matching the selected numbers of a different color; and (iii) random game indicia matching one another (i.e., unrelated to the selected numbers) across a single payline.

### FIELD OF THE INVENTION

The embodiments of the present invention relate to systems and methods for generating prizes based on primary game outcomes based on colored numbers.

### BACKGROUND

Casinos derive much of their gaming revenue from electronic gaming machines such as slot machines and video poker machines. Unfortunately, even with the introduction of new technology (e.g., curved displays), slot machines and video poker machines and the like can become stale after even short game play sessions.

Consequently, there is a constant need for new, exciting slot-style machines and video poker machines to maintain existing players and attract new players. Accordingly, the new system and method detailed herein involves a video gaming machine utilizing colored numbers as the game indicia. In this manner, winning outcomes can be based on several different combinations of the numbers as selected by the player. Thus, besides utilizing novel wining outcomes, the gaming system and method detailed herein allows players to select the winning game indicia (e.g., lucky numbers).

### SUMMARY

In one embodiment of the present invention, a gaming system or method includes a primary game display comprising a series of reels, which randomly display game indicia involving colored numbers, and a selected numbers grid. In one embodiment, the primary game display comprises three cards or paylines each having five game indicia locations/reels, each corresponding to a unique color, wherein the selected numbers grid also comprises five selected numbers, each corresponding to a unique color. During play, each of the random game indicia reels displays a random number, from a group of numbers, of a particular color. Winning outcomes relate to several factors including (i) random game indicia matching the corresponding selected number and color; (ii) random game indicia matching selected numbers of a different color; and (iii) matching game indicia matching one another (i.e., unrelated to the selected numbers) across a single card or payline.

Other variations, embodiments and features of the present invention will become evident from the following detailed description, drawings and claims.

### BRIEF DESCRIPTION OF THE DRAWINGS

FIG. 1 illustrates an exemplary gaming machine of the type that may be used to facilitate the embodiments of the present invention;

FIG. 2 illustrates a block diagram of a multiple casino property system of the type that may be used to facilitate the embodiments of the present invention;

FIG. 3 illustrates a block diagram of a wireless network system of the type that may be used to facilitate the embodiments of the present invention;

FIG. 4 illustrates a primary game display according to the embodiments of the present invention;

FIG. 5 illustrates an exemplary pay table of the type suitable for the embodiments of the present invention;

FIGS. 6A-6D illustrate a first set of exemplary winning outcomes according to the embodiments of the present invention;

FIGS. 7A-7C illustrate a second set of exemplary winning outcomes according to the embodiments of the present invention;

FIGS. 8A and 8B illustrate a third set of exemplary winning outcomes with payouts according to the embodiments of the present invention; and

FIGS. 9A and 9B illustrate a re-spin process according to the embodiments of the present invention; and

FIG. 10 illustrates a flow chart detailing play of an exemplary game according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming machine” should be understood to be any one of a general purpose computer, as for example a personal computer, laptop computer, standalone machine, a client computer configured for interaction with a server, a special purpose computer such as a server, or a smart phone, soft phone, tablet computer, personal digital assistant or any other machine adapted for executing programmable instructions in accordance with the description thereof set forth above.

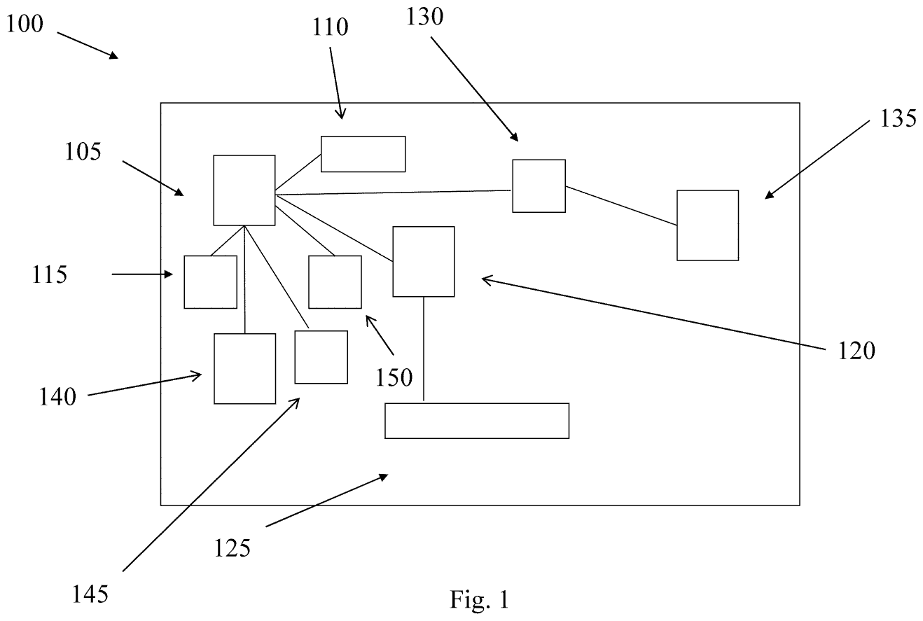

In addition to gaming tables, the embodiments of the present invention may be facilitated by an electronic gaming device allowing multiple players to play against one another under the control of a central server as described herein. Besides mobile devices, the electronic gaming device may be a standalone device and bar-top device forming part of a gaming device network or not. A block diagram of the electronic gaming device 100 is shown in FIG. 1. The exemplary electronic gaming device 100 may include a central processing unit (CPU) also deemed a processor 105 which controls the electronic gaming device 100 based on instructions stored in program read-only memory (ROM) 110 and pay table ROM 115. Program ROM 110 stores executable instructions related to the operation of the gaming device 100 and which are generally permanent. CPU 105 may be connected to a video controller 120 which provides output to one or more video displays 125. Similarly, an audio controller 130 provides audio output as dictated by the CPU 105 through speakers 135. The components, and others, may be attached to a circuit board forming a motherboard. In another embodiment, the electronic gaming device 100 may be linked to a central game server which allows players to select from games via the electronic gaming device 100. In such an embodiment, one or more processors integrated into the central server control the gaming device 100 based on instructions stored in program ROM 110.

A user interface 140 may respond to buttons on button panel or display incorporating touch screen technology or any other devices providing means for users to communicate with, and instruct, the electronic gaming device 100. Wager memory 145 stores an amount of money/credits deposited into the electronic gaming device 100 by a player and specific wager information related to each play of the electronic gaming device 100. Payout system 150 includes a coupon printer or similar device for receiving money/coupon from the electronic gaming device 100.

Those skilled in the art will recognize that the configuration and features of the electronic gaming device 100 disclosed herein are exemplary and may be altered in any number of ways without impacting the embodiments of the present invention.

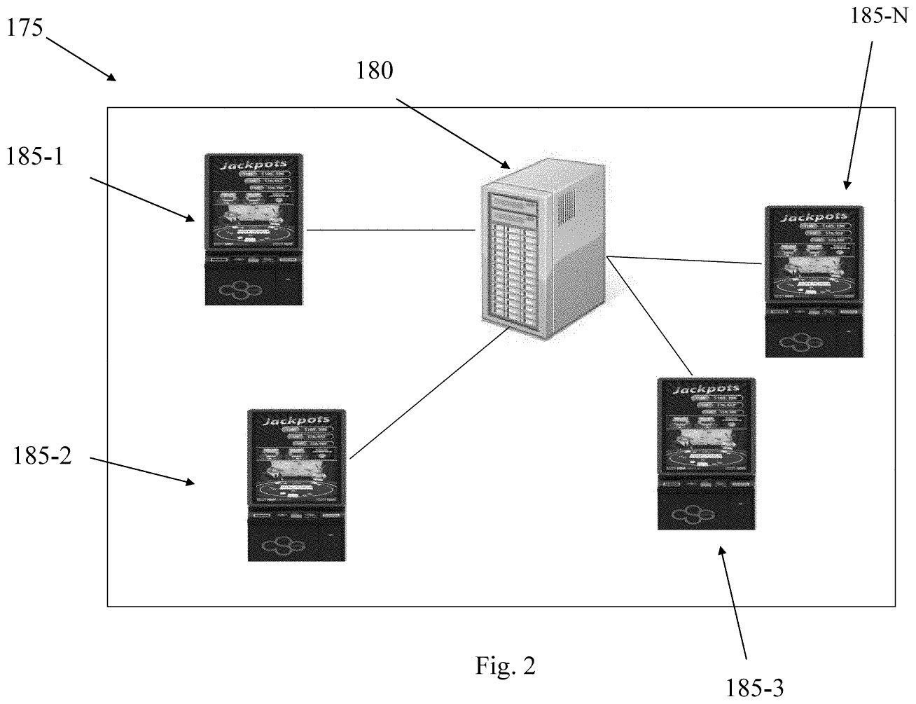

FIG. 2 shows a block diagram of a wired system 175 which may be used to facilitate play of the game according to the embodiments of the present invention. The wired system 175 comprises a central computer 180 running a casino management system or the like and including one or more processors and memory. Standalone gaming devices 185-1 through 185-N (e.g., video machines) configured to facilitate game play.

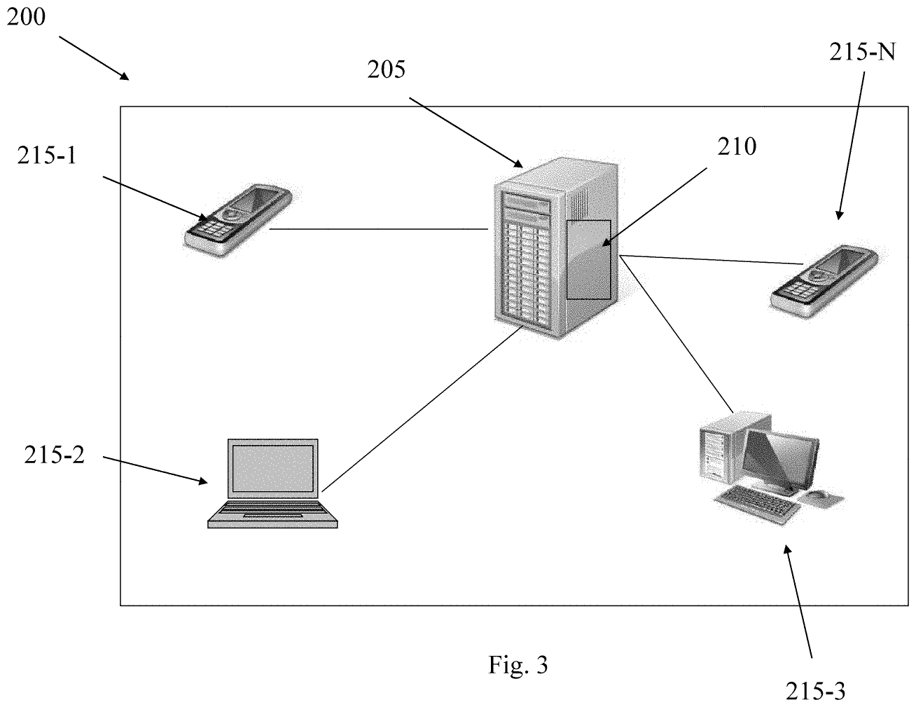

FIG. 3 shows a block diagram of a wireless system 200 which may be used to facilitate remote play of the game according to the embodiments of the present invention. The wireless system 200 comprises a game server 205, including one or more processors 210 running game software, and remote devices 215-1 through 215-N (e.g., smart phones) configured to access said game server 205 facilitating game play on the remote devices 215-1 through 215-N. In another embodiment, the video game according to the embodiments of the present invention may be in the form of a software application (“App”) downloadable onto smart phones, tablets or computers and playable via processing power and a user interface associated therewith. Wired connections may be used as well.

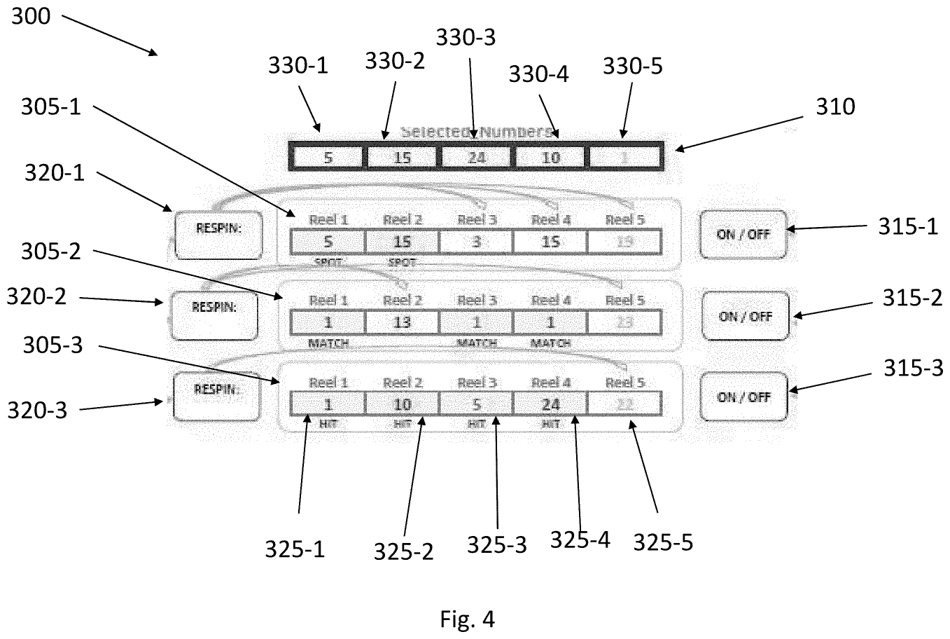

FIG. 4 shows an exemplary primary display 300 according to the embodiments of the present invention. The primary display generally depicts three cards or paylines 305-1 through 305-3, player-selected numbers grid 310, on/off icons 315-1 through 315-3 and re-spin icons 320-1 through 320-3. As shown, each card or payline 305-1 through 305-3 is formed of five reels 325-1 through 325-5. Those skilled in the art will recognize that the primary display may depict greater than or less than three paylines and each payline may be formed of greater than or less than five reels. In a traditional fashion, during play, each of the reels 325-1 through 325-5 is spun and randomly stops on a colored number from a group of numbers. Alternatively, the numbers may simply appear on the reels without any “spinning.”

In a first embodiment of the present invention, each reel 325-1 through 325-5 corresponds to a specific color. As shown, reel 325-1 corresponds to blue; reel 325-2 corresponds to red; reel 325-3 corresponds to green; reel 325-4 corresponds to purple; and reel 325-5 corresponds to yellow. The color correspondence and actual colors may be different without departing from the spirit and scope of the present invention. A selected numbers grid 310 is positioned above the three paylines 305-1 through 305-3 showing a correspondence between selected numbers 330-1 through 330-5 and game indicia on the five reels 325-1 through 325-5. The colors on numbers in each grid location match the colors of the numbers on each corresponding reel.

The selected numbers grid 310 depicts those numbers 330-1 through 330-5 selected by the player via a user interface. It is also conceivable that the player may use a random number selector to randomly select the numbers populating the selected numbers grid 310. In one embodiment, each reel accommodates 24 numbers from 1 to 24 as does each location on the selected numbers grid 310. In another embodiment, the reels may accommodate numbers from 00-99. Those skilled in the art will recognize that greater than or less than 24 or 99 numbers may be used. Moreover, the range of numbers on each reel and/or grid location may differ. In one embodiment, the game system is promoted under the fanciful name “Lucky 24 Numbers.”

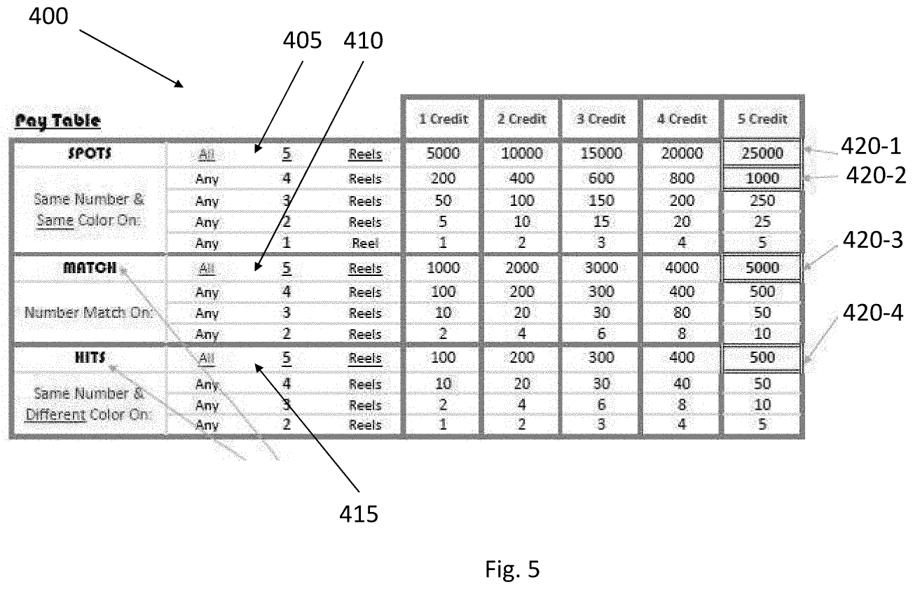

In one embodiment, winning outcomes relate to several factors including (i) random game indicia matching the selected number and color; (ii) random game indicia matching selected numbers of a different color; and (iii) matching random game indicia across a single payline (i.e., unrelated to the selected numbers). FIG. 5 shows an exemplary pay table 400 related to the possible winning outcomes. The first level of payouts relates to the random game indicia on reels matching the corresponding selected numbers forming the selected numbers grid 310. As shown in the pay table 400, one to five matches (“spots”) 405 trigger increasing payouts based on the number of credits played. The second level of payouts relates to the random game indicia on reels matching any of the selected numbers forming the selected numbers grid 330. As shown in the pay table 400, two to five matches (“hits”) 410 trigger increasing payouts based on the number of credits played. The third level of payouts relates to the random game indicia on reels matching one another irrespective of any of the selected numbers forming the selected numbers grid 310. As shown in the pay table 400, two to five matches (“matches”) 415 trigger increasing payouts based on the number of credits played.

In one embodiment, certain pre-established maximum bet (e.g., 5 credits) payouts are progressive in nature meaning they increase until they are won. The increase in the progressive awards is funded by a small percentage of each maximum bet placed. Pay table 400 identifies certain exemplary progressive payouts 420-1 through 420-4. Progressive payouts need not be utilized as fixed payouts may be used instead.

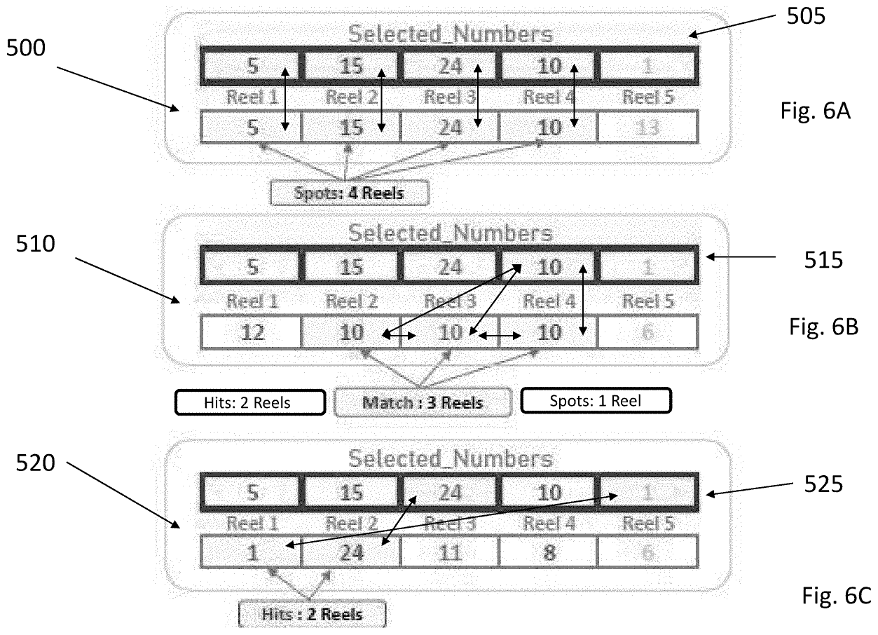

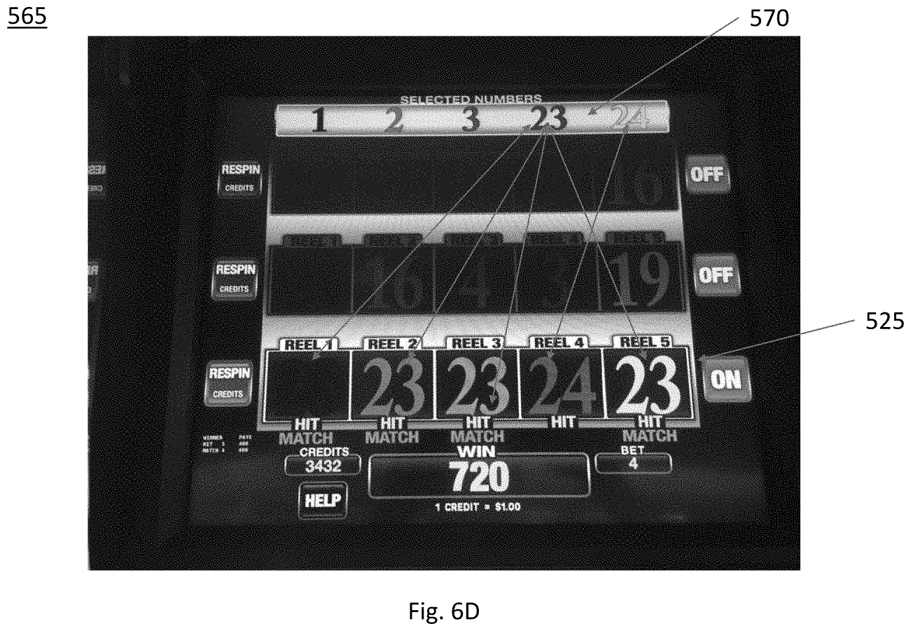

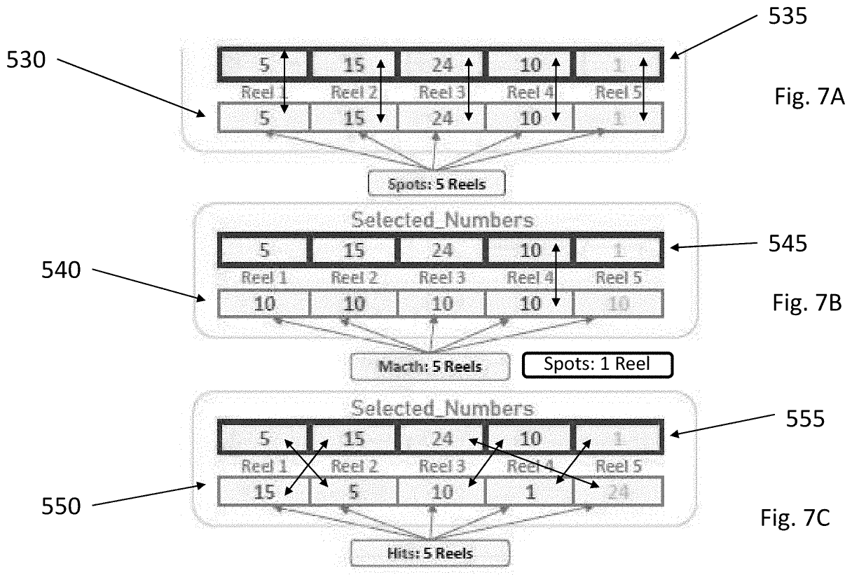

Now referring to FIGS. 6A-6D and 7A-7C, winning payouts fall into three groups termed “spots,” “matches” and “hits.” These terms are exemplary only such that any term may be used to identify the winning outcomes.

Spots relate to a match between game reel indicia and its corresponding selected number indicia. That is, reel 1 corresponds to grid location 1 of the selected numbers grid 505, reel 2 corresponds to grid location 2 and so on. FIG. 6A shows payline 500 having four reels with spots based on random reel 1 game indicia and selected game indicia at location 1 of the selected numbers grid 505 (both 5s); random reel 2 game indicia and selected game indicia at location 2 of the selected numbers grid 505 (both 15s); random reel 3 game indicia and selected game indicia at location 3 of the selected numbers grid 505 (both 24s); and random reel 4 game indicia and selected game indicia at location 4 of the selected numbers grid 505 (both 10s).

Matches relate to a match between random game reel indicia on different reels without any relationship to the selected number indicia on selected numbers grid 515. FIG. 6B shows payline 510 with game indicia on reels, 2, 3 and 4 matching one another (all 10s). In this instance there is also a second payout for the single spot based on random reel 4 game indicia and selected game indicia at location 4 of the selected numbers grid 505 (both 10s) and third payout for hits based on random reel 2 game indicia matching selected number indicia at grid location 4 of the selected numbers grid 525 and random reel 3 game indicia matching selected number indicia at grid location 4 of the selected numbers grid 525 (all 10s). In other words, multiple payouts may be awarded based on the various combinations. In another example shown in FIG. 6D, 5 hits and 4 matches are shown and paid.

Hits relate to a match between game reel indicia and any selected number indicia regarding of location. FIG. 6C shows payline 520 having hits on reel 1 and reel 2. Random reel 1 game indicia matches selected number indicia at grid location 4 of the selected numbers grid 525 (both 1s) and random reel 2 game indicia matches selected number indicia at grid location 3 of the selected numbers grid 525 (both 24s).

Now referring to FIGS. 7A-7C, payline 530 and selected numbers grid 535 show five reels with spots; payline 540 show five reels with matches; and payline 550 and selected numbers grid 555 show five reels with hits.

Pay table 400 provides exemplary payouts associated with the winning outcomes shown in FIGS. 6A-6D and 7A-7C. For example, referring to FIGS. 6A-6D, payline 500 (4 spots) results in a payout of 200-1 for a bet of 1 to 4 credits and a progressive payout for a bet of 5 credits; payline 510 (1 spot, 2 hits and 3 matches) results in a spot payout of 1 to 1 for a bet of 1 to 5 credits, a hits payout of 1 to 1 for a bet of 1 to 5 credits and matches payout of 10 to 1 for a bet of 1 to 5 credits; payline 520 (2 hits) results in a payout of 1-1 for a bet of 1 to 5 credits; and payline 525 (5 hits and 4 matches) results in a hits payout of 100 to 1 for a bet of 1-4 credits and a progressive payout for a bet of 5 credits and a matches payout of 100 to 1 for a bet of 1 to 5 credits.

Now referring to FIGS. 7A-7C, payline 530 (5 spots) results in a payout of 5000-1 for a bet of 1 to 4 credits and a progressive payout for a bet of 5 credits; payline 540 (1 spot and 5 matches) results in a spot payout of 1 to 1 for single spot and 1000-1 for a bet of 1 to 4 credits and a progressive payout for a bet of 5 credits for 5 matches; and payline 550 (5 hits) results in a payout of 100-1 for a bet of 1 to 4 credits and a progressive payout for a bet of 5 credits.

While FIGS. 4, 6A-6D, 7A-7C and 8A and 8B show only reel indicia in the form of numbers, in certain embodiments other reel game indicia may be included. In one embodiment, a joker or wild symbol (e.g., 4 leaf clover) may be used to complete or increase a winning payout. In another embodiment, a free spin symbol may be used to award free spins. In another embodiment, a bonus wheel symbol may be used to allow a player to play a bonus game comprising a bonus wheel. Any or all of the features may be combined into a single embodiment.

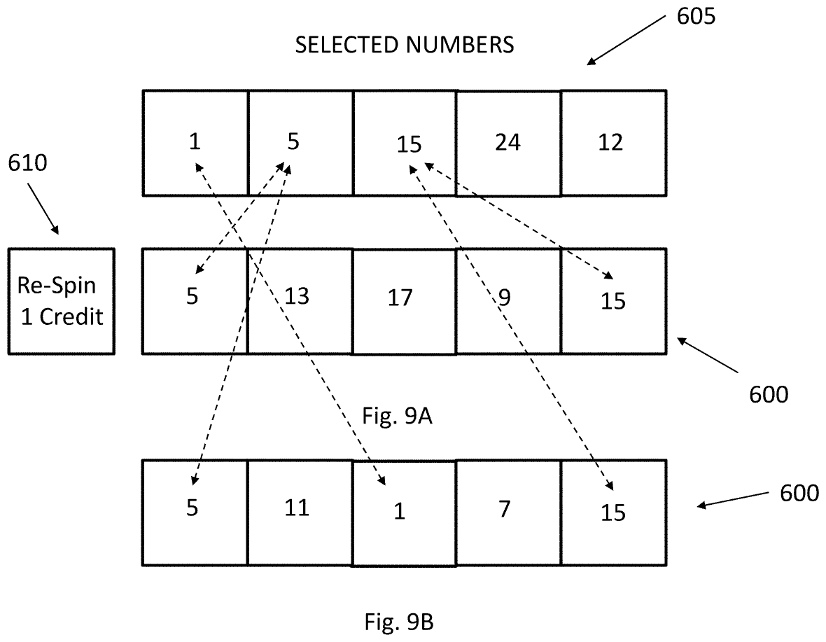

Now referring to FIGS. 4 and 9A and 9B, re-spin icons 320-1 through 320-3 provide opportunities for players to generate a re-spin of any payline that originally produced a winning outcome. If the payline had at least one winning outcome (e.g., 2 hits), the player may re-spin the reels of that payline that were not involved with the original winning outcome. For example, as shown in FIG. 9A, after a first spin, reels 1 and 5 of payline 600 and locations 2 and 3 of selected numbers grid 605 result in two hits and associated payout (e.g., 1 to 1 as shown in pay table 400) such that the player has an option to re-spin reels 2, 3 and 4 of payline 600 in an effort to improve the winning outcome. Re-spin icon 610 shows that 1 credit is required for the re-spin. The cost 605 of the re-spin to the player is determined by the system software based on the odds of the re-spin improving the winning outcome. As shown in FIG. 9B, the re-spin results in another hit, namely reel 3 of payline 600 and location 1 of the selected numbers grid 605 resulting in a 3 hit outcome and payout of 2 to 1 as shown in pay table 400.

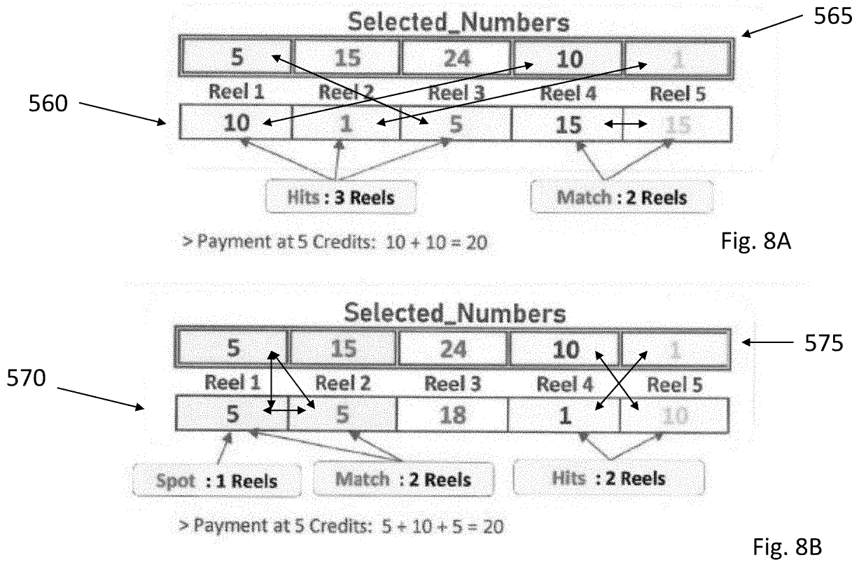

FIGS. 8A and 8B show payout calculation for certain winning outcomes. Payline 560 and selected numbers grid 565 of FIG. 8A show 3 reels with hits and 2 reels with matches. Based on pay table 400, 3 reels with hits pays 2 to 1 and 2 reels with matches pays 2 to 1 such that a bet of 5 credits results in a total 20-credit payout (2×5 credits+2×5 credits). Payline 570 and selected numbers grid 575 of FIG. 8B show 1 reel with a spot, 2 reels with matches and 2 reels with hits. Based on pay table 400, 1 reel with a spot pays 1 to 1, 2 reels with matches pays 2 to 1 and 2 reels with hits pays 1 to 1 such that a bet of 5 credits results in a total 20-credit payout (1×5 credits+2×5 credits+1×5 credits).

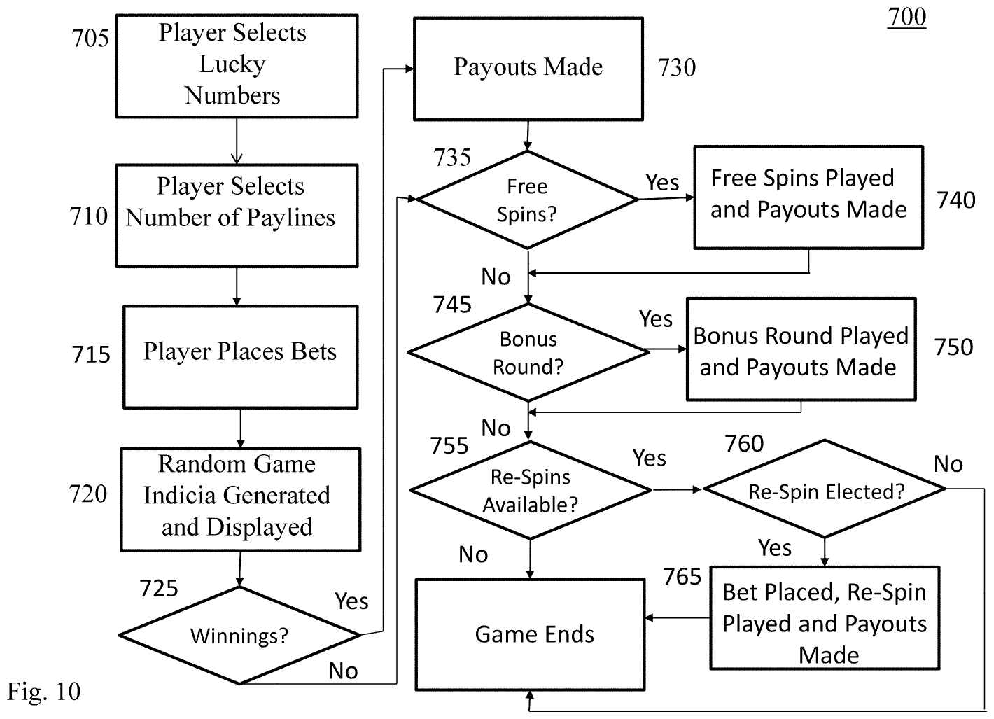

FIG. 10 shows a flow chart 700 detailing one method of play according to the embodiments of the present invention. At step 705, a player selects the five numbers to populate the selected numbers grid. The selection is made via a user interface (e.g., touchscreen display). In one embodiment, the player may individually select the numbers and/or randomly select one or more of the numbers. In one embodiment, the player may select 1 number for each grid location between 1 and 24 (same as the game indicia on each reel). At step 710, the player selects a number of paylines to activate. Using FIG. 4 as the reference display, the player may choose, 1, 2 or 3 active paylines. Of course, in other embodiments, a greater or lesser number of paylines may be available. At step 715, the player places bets from 1 to 5 credits. At step 720, random numbers are generated and displayed on the five reels of each active payline. In this instance, each reel of each payline accommodates 24 numbers from 1 to 24 (same as the grid locations of the selected numbers grid). At step 725, it is determined if any payline depicts a winning outcome. The winning outcome may factor in the joker or wild symbol if implemented. At step 730, if there are any winning outcomes, corresponding payouts are made. At step 735, it is determined if any free spin indicia have appeared. If so, at step 740, the player is presented with the free spins and paid any additional winnings. At step 745, it is determined if a bonus round has been reached (e.g., one or more bonus wheel indicia appearing on the reels). If so, at step 750, the player is presented with the bonus round and paid any additional winnings. At step 755, it is determined if any re-spin options are available. If so, at step 760, the player has the option to re-spin or decline. If the player elects to re-spin, at step 765, the player places the required bet, causes the re-spin and any additional winning payout based on the re-spin is made. At step 770, the game ends.

While the terms “reels” and “paylines” have been used, it is known that the random game indicia (e.g., colored numbers) may simply “pop” onto or appear on the reels akin to conventional video poker. That is, no spinning of game indicia needs take place as is common with conventional slot machines.

Although the invention has been described in detail with reference to several embodiments, additional variations and modifications exist within the scope and spirit of the invention as described and defined in the following claims.

I claim:

1. A gaming system comprising:
a monetary input device configured to receive a physical item associated with a monetary value;
a user interface configured to:
enable a player to select a wager for a game of chance and enable the player to initiate a cash out operation;
at least one processor running executable instructions related to a game of chance;
said at least one processor programmed to:
add said monetary value to a credit balance for said player;
deduct said selected wager from said credit balance; and
decrease said credit balance in response to said cash out operation;
one or more displays depicting a selected numbers grid having a plurality of locations equivalent to a number of primary game indicia locations for each of one or more primary game indicia sets;
memory in communication with said at least one processor; and
wherein said at least one processor runs said executable instructions to: (i) accept user inputs to populate locations of said selected numbers grid with numbers from a first group of numbers; (ii) generate and display at least one random primary game indicia set comprising numbers from a second group of numbers in locations corresponding to said populated selected numbers grid; (iii) compare said at least one random primary game indicia set to each of said locations of said populated selected numbers grid, and each random game indicia forming said at least one random primary game indicia set to one another; and (iv) determine payouts, if any, based on said comparison of said at least one random primary game indicia set to each of said locations of said populated selected numbers grid, and each random game indicia forming said at least one random primary game indicia set to one another.

2. The gaming system of claim 1 wherein said selected numbers grid has five locations and said primary game indicia sets have five random primary game indicia.

3. The gaming system of claim 1 wherein winning payouts correspond to spots, matches and hits.

4. The gaming system of claim 1 further comprising wherein said at least one processor runs said executable instructions to: provide re-spins for a fee.

5. The gaming system of claim 1 further comprising wherein said at least one processor runs said executable instructions to: provide free spins.

6. The gaming system of claim 1 further comprising wherein said at least one processor runs said executable instructions to: provide a bonus game.

7. The gaming system of claim 1 wherein said first group of numbers and said second group of numbers comprise numbers 1 through 24.

8. The gaming system of claim 1 wherein said game indicia in each location have a unique color relative to game indicia in other locations, and wherein selected numbers in each location of said selected numbers grid corresponding to each game indicia location have a same unique color.

9. A gaming system comprising:
a monetary input device configured to receive a physical item associated with a monetary value;
a user interface configured to:
enable a player to select a wager for a game of chance and enable the player to initiate a cash out operation;
at least one processor running executable instructions related to a game of chance;
said at least one processor programmed to:
add said monetary value to a credit balance for said player;
deduct said selected wager from said credit balance; and
decrease said credit balance in response to said cash out operation;
one or more game displays depicting a selected numbers grid having five locations and one or more primary game indicia sets comprising five reels each corresponding to one of said locations of said selected numbers grid;
memory in communication with said at least one processor; and
wherein said at least one processor runs said executable instructions to: (i) accept user inputs to populate said five locations of said selected numbers grid from a first group of numbers; (ii) generate and display at least one set of random game indicia from a second group of numbers in each reel of said one or more primary game indicia sets; (iii) compare each reel of each one or more random game indicia sets to each location of said populated selected numbers grid, and each of said random game indicia forming each random game indicia set to one another; and (iv) determine payouts, if any, based on said comparison of said each reel of each one or more random game indicia sets to each location of said populated selected numbers grid, and each of said random game indicia forming each random game indicia set to one another.

10. The gaming system of claim 9 wherein winning payouts correspond to spots, matches and hits.

11. The gaming system of claim 9 further comprising wherein said at least one processor runs said executable instructions to: provide re-spins for a fee.

12. The gaming system of claim 9 further comprising wherein said at least one processor runs said executable instructions to: provide free spins.

13. The gaming system of claim 9 further comprising wherein said at least one processor runs said executable instructions to: provide a bonus game.

14. The gaming system of claim 9 wherein said game indicia on each of said five reels have a unique color relative to game indicia on other reels, and wherein selected numbers in each of said five locations of said selected numbers grid location corresponding to each reel have a same unique color.

15. A gaming system comprising:
a monetary input device configured to receive a physical item associated with a monetary value;
a user interface configured to:
enable a player to select a wager for a game of chance and enable the player to initiate a cash out operation;
at least one processor running executable instructions related to a game of chance;
said at least one processor programmed to:
add said monetary value to a credit balance for said player;
deduct said selected wager from said credit balance; and
decrease said credit balance in response to said cash out operation;
one or more game displays depicting a selected numbers grid having a plurality of locations from 1 to N and number of primary game indicia locations from 1 to N for each of one or more primary game indicia sets;
memory in communication with said at least one processor; and
wherein said at least one processor runs said executable instructions to: (i) accept user inputs to populate locations 1 to N of said selected numbers grid with numbers from a first group of numbers; (ii) generate and display at least one random primary game indicia set comprising numbers from a second group of numbers in locations 1 to N corresponding to locations 1 to N of said populated selected numbers grid; (iii) compare locations 1 to N of said at least one random primary game indicia set to each of said locations 1 to N of said populated selected numbers grid, and each random game indicia forming said at least one random primary game indicia set to one another; and (iv) determine payouts, if any, based on said comparison of said locations 1 to N of said at least one random primary game indicia set to each of said locations 1 to N of said populated selected numbers grid, and each random game indicia forming said at least one random primary game indicia set to one another.

16. The gaming system of claim 15 wherein N equals 5.

17. The gaming system of claim 15 wherein winning payouts correspond to spots, matches and hits.

18. The gaming system of claim 15 further comprising wherein said at least one processor runs said executable instructions to: provide re-spins for a fee.

19. The gaming system of claim 15 further comprising wherein said at least one processor runs said executable instructions to: provide free spins.

20. The gaming system of claim 15 further comprising wherein said at least one processor runs said executable instructions to: provide a bonus game.
